(19) United States
(12) Patent Application Publication
(10) Pub. No.: US 2005/0025486 A1
(43) Pub. Date: Feb. 3, 2005

(54) Bi-directional wavelength division multiplexing module

(76) Inventors: Johnny Zhong, Hayward, CA (US); Steve Wang, San Jose, CA (US); Frank Levinson, Palo Alto, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/910,424

(22) Filed: Aug. 2, 2004

Related U.S. Application Data
(60) Provisional application No. 60/492,181, filed on Aug. 1, 2003.

(51) Int. Cl. H04J 14/02

(52) U.S. Cl. 398/79

(57) ABSTRACT

Optical systems route signals bi-directionally on a single fiber. The bidirectional data transmission over a single fiber can be used for WDM systems, including for example both CWDM and DWDM systems. The systems can include devices, such as interleavers, bandpass filter, and circulators, which are used in pairs at opposite ends of an optical fiber to couple signals into a bidirectional signal over the optical fiber. The use of a circulator enables signals traveling in opposite directions on the single fiber to occupy the same wavelength channels.

This application claims the benefit of U.S. Provisional Application No. 60/492,181, filed Aug. 1, 2003, which is hereby incorporated herein by reference.

### BACKGROUND OF THE INVENTION

1. The Field of the Invention

The present invention relates generally to high speed communications systems and methods. More particularly, embodiments of the invention relate to systems and methods for providing bi-directional multiplexed data transfer over single fibers.

2. The Relevant Technology

Computer and data communications networks continue to develop and expand due to declining costs, improved performance of computer and networking equipment, the remarkable growth of the internet, and the resulting increased demand for communication bandwidth. Such increased demand is occurring both within and between metropolitan areas as well as within communications networks, such as wide area networks (“WANs”), metropolitan area networks (“WANs”), and local area networks (“LANs”). These networks allow increased productivity and utilization of distributed computers or stations through the sharing of resources, the transfer of voice and data, and the processing of voice, data, and related information at the most efficient locations.

Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of fiber optic systems required.

Through fiber optics, digital data in the form of light signals is formed by light emitting diodes or lasers and then propagated through a fiber optic cable. Such light signals allow for high data transmission rates and high bandwidth capabilities. Other advantages of using light signals for data transmission include their resistance to electromagnetic radiation that interferes with electrical signals; fiber optic cables' ability to prevent light signals from escaping, as can occur electrical signals in wire-based systems; and light signals' ability to be transmitted over great distances without the signal loss typically associated with electrical signals on copper wire.

Another advantage in using light as a transmission medium is that multiple wavelength components of light can be transmitted through a single communication path such as an optical fiber. This process is commonly referred to as wavelength division multiplexing (WDM), where the bandwidth of the communication medium is increased by the number of independent wavelength channels used. A relatively high density of wavelengths channels can be transmitted using dense wavelength division multiplexing (DWDM) and coarse wavelength-division multiplexing (CWDM) applications where the individual wavelength communication channels are closely spaced to achieve higher channel density and total channel number in a single communication line. CWDM typically implements a channel spacing of 20 nanometers and DWDM typically implements a channel spacing of 0.8 nanometers. Thus, CWDM thereby allows a modest number of channels, typically eight or less, to be stacked in the 1550 nm region of the fiber called the C-Band. CWDM transmission may occur at one of eight wavelengths: typically 1470 nm, 1490 nm, 1510 nm, 1530 nm, 1550 nm, 1570 nm, 1590 nm, 1610 nm. DWDM systems, in contrast, typically have up to forty channels.

WDM systems with dual fibers typically use unidirectional signal transmission on each fiber to accommodate the optical traffic in each direction. For example, as indicated in FIG. 1, a conventional forty channel DWDM dual line system 10 has two transceiver sets 12, 14 at each end of the dual line system 10. In the depicted example, the transceivers can be gigabit interface converters (“GBICs”) which convert serial electric signals to serial optical signals and vice versa. GBICs transfer data at one gigabit per second (1 Gbps) or more. GBIC modules also allow technicians to easily configure and upgrade electro-optical communications networks because the typical GBIC transceiver is a plug-in module that is hot-swappable (it can be removed and replaced without turning off the system).

Multiplexers 16, 18 at each of the dual lines receive the optical z signals generated by the forty transceivers at each end of the line and multiplex them into forty channel multiplexed signals which are then transmitted down the dual lines 20, 22 in opposite directions. The multiplexed signals are received by demultiplexers 24, 26, split into the forty individual signals, and passed to transceiver sets 12 and 14 for conversion to electrical signals.

The main disadvantage in dual line systems is the cost in creating, maintaining, purchasing, or leasing a dual line system. For example, businesses having multiple campuses often rent lines for communication across external networks. The cost of renting the lines is set in part by the number of fibers and the length over which they travel. By way of example, a forty kilometer dual line fiber rental at one hundred dollars per month per kilometer would run eight thousand dollars per month.

Since the field of optical communications is a competitive industry with tight profit margins, there is a continuing need for improved and less expensive methods and devices for decreasing the cost of data transmission.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a prior art DWDM dual line system;

FIG. 2 illustrates a fiber optic bidirectional system according to one embodiment of the invention;

FIG. 3 depicts a fiber optic bi-directional system according to another embodiment of the invention;

FIG. 4 depicts yet another fiber optic bi-directional system according to yet another embodiment of the invention;

FIG. 5 depicts details of a CWDM bidirectional system according to another embodiment of the invention; and

FIG. 6 depicts details of a DWDM bi-directional system according to yet a further embodiment of the invention.

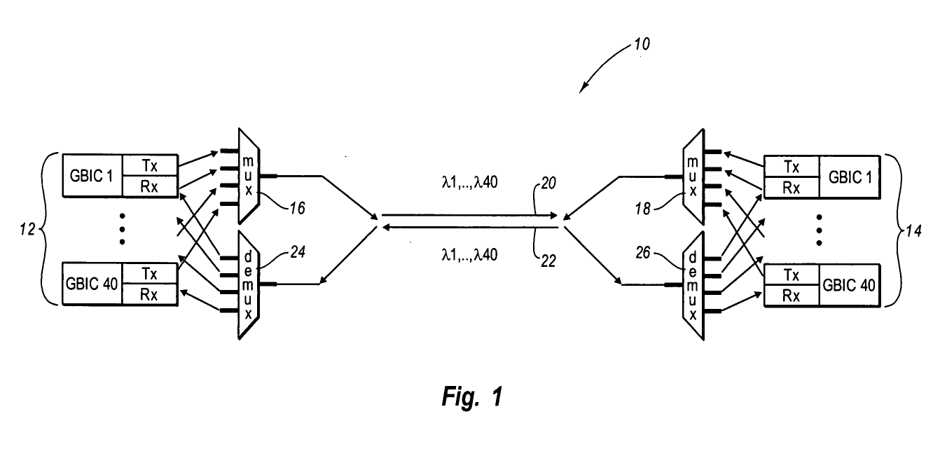

### BRIEF SUMMARY OF THE INVENTION

The present invention relates to the use of systems and methods to send multiplexed signals bi-directionally on a single fiber. More particularly, the present invention uses systems of the optical devices disclosed herein to enable bi-directional data transmission in WDM systems, such as CWDM and DWDM, over a single fiber.

Accordingly, a first example embodiment of the invention is a bi-directional wavelength division multiplexing system for providing bi-directional communications over a single fiber. The system generally includes: a multiplexer for receiving an plurality of optical signals and multiplexing the plurality of optical signals into a first multiplexed signal; a demultiplexer for receiving a second multiplexed signal and separating the second multiplexed signal into distinct optical signals over separate wavelength channels; and an optical device, for example an interleaver, a bandpass filter, or a circulator. The optical device is configured to: receive the first multiplexed signal from the multiplexer and route the first multiplexed signal onto an optical fiber such that the first multiplexed signal travels in an opposite direction as the second multiplexed signal traveling on the optical fiber; and receive the second multiplexed signal from the optical fiber and route the second multiplexed signal to the demultiplexer.

Another example embodiment of the invention is also a bi-directional wavelength division multiplexing system. This example system generally includes: a first plurality of transceivers, each of the first plurality of transceivers operable to transmit an optical signal over a selected wavelength channel; a first multiplexer for receiving an optical signal from each of the first plurality of transceivers and multiplexing the optical signals into a first multiplexed signal; a first demultiplexer for receiving a second multiplexed signal and separating the second multiplexed signal into distinct optical signals over separate wavelength channels and directing each respective one of the optical signals to a respective one of the transceivers; and a first optical device for example an interleaver, a bandpass filter, or a circulator. The optical device is configured to: receive the first multiplexed signal and direct the first multiplexed signal onto an optical fiber such that the first multiplexed signal travels in an opposite direction as a second multiplexed signal on the optical fiber; and receive the second multiplexed signal from the optical fiber and route the second multiplexed signal to the first demultiplexer.

Yet another non-limiting example embodiment of the invention is a method for increasing data transmission capacity over a single fiber. The method generally includes: receiving, at a first circulator, a first multiplexed DWDM signal over a first optical fiber and a second multiplexed DWDM signal over a second optical fiber, the first multiplexed DWDM signal comprising at least one optical signal that shares a wavelength channel with an optical signal in the second multiplexed DWDM signal, wherein the circulator couples the first multiplexed signal onto the second optical fiber and couples the second multiplexed signal onto a third optical fiber that is in communication with a DWDM demultiplexer.

These and other objects and features of the present invention will become more fully apparent from the following description and appended claims, or may be learned by the practice of the invention as set forth hereinafter.

### DETAILED DESCRIPTION OF THE PREFERRED EMBODIMENTS

The present invention relates to the use of systems and methods to send signals both upstream and downstream on a single fiber. Whereas conventional systems route signals over dual fiber systems, the present invention uses optical devices to enable bi-directional data transmission in CWDM and DWDM systems over a single fiber.

In various embodiments of the present invention, the herein disclosed systems include signal coupling devices to couple signals that are conventionally transmitted unidirectionally over dual fibers in a bidirectional (“BiDi”) signal over a single fiber. These coupling devices include, for example, interleavers, bandpass filters, and circulators.

As used herein, the terms “optical fiber” and “single fiber” are inclusive of other optical devices that may be interposed in a continuous optical path that commence and end with a single fiber. Hence, the term “single fiber” may include a fiber stub that is attached at a first optical device, intermediate optical devices that sever the fiber, such as optical add delete multiplexers, yet nevertheless propagate at least some of the optical signals on the fiber, and a fiber stub that is attached to a second optical device. In other words, the recitation of a “single fiber” or an “optical fiber” between two nodes does not require the use of a single continuous fiber to span the entire distance between the nodes.

Reference will now be made to the drawings to describe various aspects of exemplary embodiments of the invention. It is to be understood that the drawings are diagrammatic and schematic representations of such exemplary embodiments, and are not limiting of the present invention, nor are they necessarily drawn to scale.

In the following description, numerous specific details are set forth in order to provide a thorough understanding of the present invention. It will be obvious, however, to one skilled in the art that the present invention may be practiced without these specific details. In other instances, well-known aspects of network systems have not been described in particular detail in order to avoid unnecessarily obscuring the present invention.

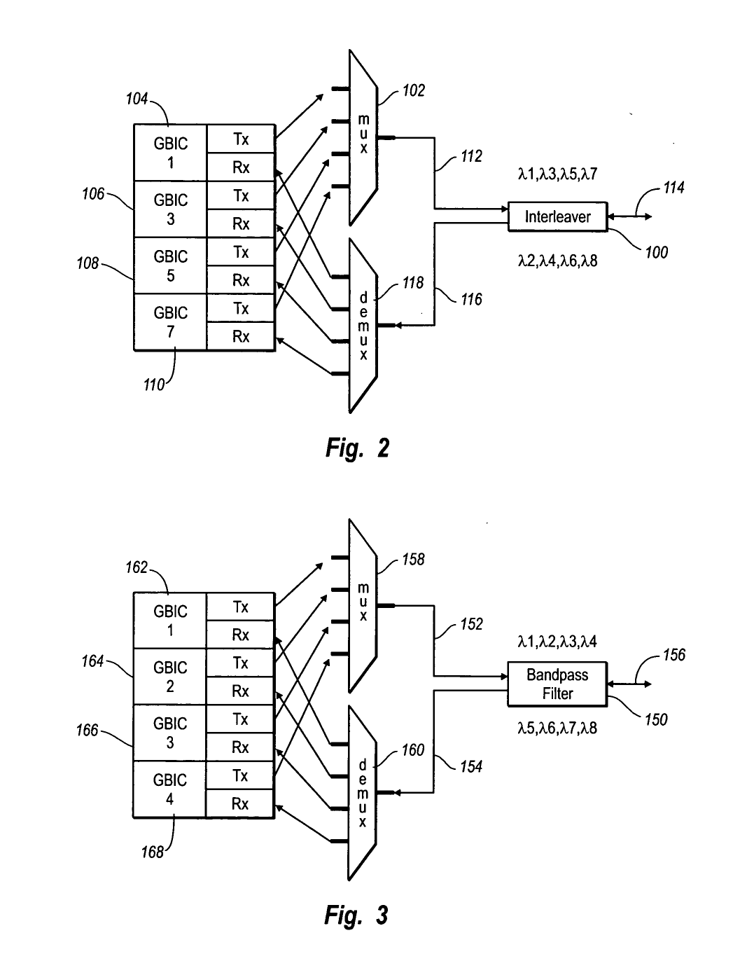

Referring now to FIG. 2, one device for coupling unidirectional signals on dual fibers into a single BiDi fiber is an interleaver 100. An interleaver is a device used to combine odd and even numbered wavelengths from separate fibers into a single fiber. For example, the interleaver 100 can receive a second multiplexed signal from fiber 114. This second multiplexed signal contains signals over the even numbered wavelengths λ2, λ4, λ6, λ8. This second multiplexed signal is coupled into third fiber 116 and on to demultiplexer 118.

A demultiplexer generally takes as its input an optical transmission that includes a number of individual signals, with each signal being transmitted using a particular wavelength of light. By way of example, demultiplexer 118 has an input port by which it receives the second multiplexed signal from optical fiber 116. The optical demultiplexer 118 can be a passive device, meaning that no external power or control is needed to operate the device. Using a combination of passive components, such as thin-0<film three-port devices, mirrors, birefringent crystals, etc., the demultiplexer 118 separates the multiplexed signal in optical signal 104 into its constituent parts. Alternatively, demultiplexer 118 can be an active device. Regardless, each of the individual wavelengths, each representing a separate signal on a communication channel, is then output to an output port an on to a corresponding one of transceivers 104, 106, 108, and 100. Although the depicted transceivers are GBICs, it will be appreciated that other transceivers may also compatible with embodiments of the invention.

Also in communication with interleaver 100 is multiplexer 116. A multiplexer such as multiplexer 216 functions in the inverse manner as a demultiplexer. In fact, multiplexers can often be constructed from demultiplexers simply by using the output ports as input ports and the input port as an output port. In the depicted embodiment, a multiplexer 102 receives four odd numbered optical signals, λ1, λ3, λ5, λ7, from transceivers 104, 106, 108, 110 and couples the four signals, λ1, λ3, λ5, λ7, into a first multiplexed signal on first fiber 112. The first multiplexed signal is then communicated to interleaver 100 by first fiber 112. Interleaver 100 couples the first multiplexed signal onto second fiber 114.

In this manner, the interleaver 100 passively couples unidirectional signals over two fibers 112, 116 to and from a single bidirectional fiber without mixing the signals. This enables the use of a single fiber for optical communication in networks such as over LANs or MANs, for example between business campuses and other networks. In contrast and as previously noted, conventional systems use dual fibers for the same purpose.

Similarly, a bandpass filter 150, as depicted in FIG. 3, also couples unidirectional signals over two fibers 152, 154 to and from a single bi-directional fiber 156 without mixing the signals. Unlike an interleaver, however, a bandpass filter operates by allowing signals between specific wavelength frequencies to pass, but discriminates against signals at other wavelength frequencies. Bandpass filter 150 may be either an active bandpass filter and require an external source of power and employ active components such as transistors and integrated circuits or be a passive bandpass filter, requiring no external source of power and consisting only of passive components.

Accordingly, in the depicted embodiment of FIG. 3, a multiplexer 158 receives four optical signals, λ1, λ2, λ3, λ4, from transceivers 162, 164, 166, 168 and couples the four signals, λ1, λ2, λ3, λ4, into a first multiplexed signal on first fiber 152. This first multiplexed signal is then relayed to bandpass filter 150 by first fiber 152. Bandpass filter 150 receives the first multiplexed signal and couples the first multiplexed signal onto second fiber 156.

The bandpass filter 150 also receives a second multiplexed signal from second fiber 156, but from the opposite direction as the first multiplexed signal. The second multiplexed signal contains signals over a second range of wavelength frequencies λ5, λ6, λ7, λ8. This second multiplexed signal is coupled into third fiber 154 and on to demultiplexer 160. Demultiplexer 160 divides the multiplexes signal into its component signals over wavelengths λ5, λ6, λ7, λ8 and then couples each of the signals to one of transceivers 162, 164, 166, 168.

Thus, the bandpass filter 150 passively or actively couples unidirectional signals over two fibers 152, 154 to and from a single bi-directional fiber 156 without mixing the signals.

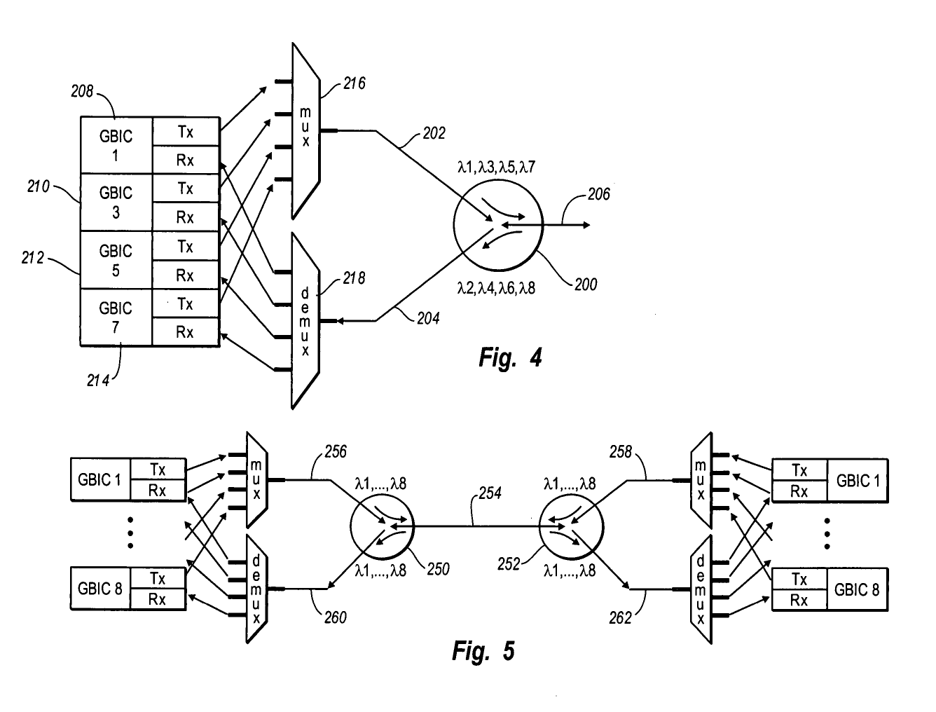

Referring now to FIG. 4, a circulator 200 can be used to couple 0<unidirectional signals over two fibers 202, 204 to and from a single bi-directional fiber 206 without mixing the signals. A circulator is generally a passive device having three ports that couples light from port 1 to port 2 and from port 2 to port 3 while having high isolation in the other directions. In the depicted example, the circulator does even-odd separation, although various forms of routing are possible with a circulator, including both even-odd and continuous band separation as well as sending and receiving signals over the same wavelength channels.

For example, in FIG. 4 it can be seen that multiplexer 216 receives four optical signals, λ1, λ3, λ5, λ7, from transceivers 208, 210, 212, 214 and couples the four signals, λ1, λ3, λ5, λ7, into a first multiplexed signal on first fiber 202. The first multiplexed signal is then communicated to circulator 200 by first fiber 202. Circulator 200 in turn couples the first multiplexed signal onto second fiber 206 while having isolation from third fiber 204.

The circulator 200 also receives a second multiplexed signal from second fiber 206. The second multiplexed signal contains signals over a second range of wavelength frequencies λ2, λ4, λ6, λ8. This second multiplexed signal is coupled into third fiber 204 with a high degree of isolation from first fiber 202. The second multiplexed signal is then coupled to demultiplexer 218. Demultiplexer 218 divides the multiplexed signal into its component signals over wavelengths frequencies λ2, λ4, λ6, λ8 and then couples each of the signals to one of transceivers 208, 210, 212, 214.

Thus, the circulator 200 passively couples unidirectional signals over two fibers 216, 218 to and from a single bi-directional fiber 206 without mixing the signals.

Each of the interleavers, bandpass filters, and circulators discussed above can be used with various WDM systems, such as CWDM and DWDM systems. For example, in each of FIGS. 2-4 eight channels are split so that four travel in each direction in a CWDM system.

In addition, in the embodiment depicted in FIG. 5, circulators can be used to double the per fiber capacity in a CWDM system so that instead of four channels per direction, eight channels per direction are used. This is performed by having a pair of circulators 250, 252 at either end of a single fiber 254 used for CWDM BiDi data transmission. First circulator 250 couples a first optical signal from a first fiber 256 to a second fiber 254 with high isolation in the other directions. Similarly, second circulator 252 couples a second optical signal from a third fiber 258 to a second fiber 254 with high isolation in the other directions. First circulator 250 also receives and couples the second optical signal from second fiber 254 to fourth fiber 260 with high isolation in the other directions. Finally, second circulator 252 couples the first optical signal from second fiber 254 to fifth fiber 262 with high isolation in the other directions. In contrast to the previous embodiments, circulators employed according to his embodiment enable the passage of signals over the same wavelength channels in each direction. In this manner, circulators enable the use of BiDi transmission over a single fiber without sacrificing the number of channels.

One challenge that arises in using the pair of circulators to enable the double per fiber capacity is band cross talk due to optical reflection from connectors and z 0M receivers. According to the invention this problem can be overcome by using angled physical contact (“APC”) connectors and controlling the receiver reflection by devices known in the art, such as antireflective coatings. An APC connector is a style of fiber optic connector with a 5°-15° angle on the connector tip for the minimum possible backreflection.

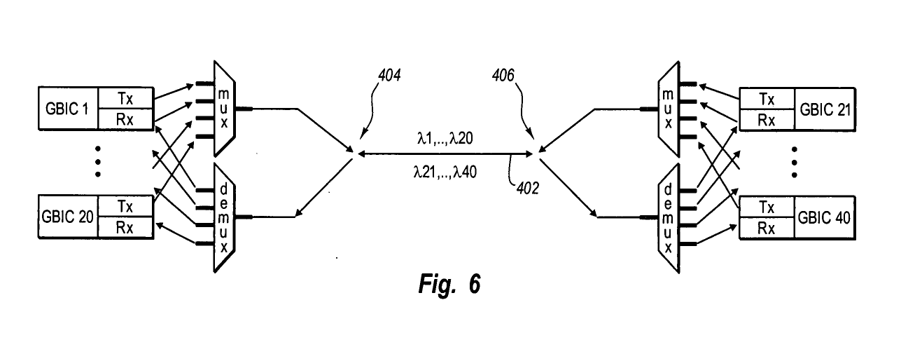

It will also be appreciated according to the disclosure herein that a DWDM signal can also be split into two sets of individual signals traveling in opposite direction down the same single fiber 402, as depicted in FIG. 6. Interleavers, bandpass filters, and circulators can be used for this purpose at points 404, 406. Hence, a forty channel DWDM system, for example, can be split into two twenty channel signals as depicted.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A bi-directional wavelength division multiplexing system for providing bi-directional communications over a single fiber, comprising:
a first multiplexer for receiving an plurality of optical signals and multiplexing the plurality of optical signals into a first multiplexed signal;
a first demultiplexer for receiving a second multiplexed signal and separating the second multiplexed signal into distinct optical signals over separate wavelength channels; and
a first optical device that is configured to:
receive the first multiplexed signal from the first multiplexer and route the first multiplexed signal onto an optical fiber such that the first multiplexed signal travels in an opposite direction as the second multiplexed signal traveling on the optical fiber; and
receive the second multiplexed signal from the optical fiber and route the second multiplexed signal to the first demultiplexer.

2. A system as in claim 1, wherein the first optical device comprises an interleaver for even-odd channel separation.

3. A system as in claim 1, wherein the first optical device comprises a bandpass filter and each signal in the first multiplexed signal has a higher wavelength than each signal in the second multiplexed signal.

4. A system as in claim 1, wherein the first optical device comprises a bandpass filter and each signal in the first multiplexed signal has a lower wavelength than each signal in the second multiplexed signal.

5. A system as in claim 1, wherein the first optical device comprises a circulator.

6. A system as in claim 1, wherein the wavelength channels for the optical signals in the first multiplexed signal and the wavelength channels for the optical signals in the second multiplexed signal have a one-to-one correspondence such that each optical signal traveling in the first multiplexed signal shares a wavelength channel with an optical signal traveling in the second multiplexed signal.

7. A system as in claim 1, wherein at least one optical signal traveling in the first multiplexed signal shares a wavelength channel with an optical signal traveling in the second multiplexed signal.

8. A system as in claim 7, further comprising at least one APC connector to reduce channel cross talk.

9. A system as in claim 1, wherein each optical signal comprises a DWDM signal.

10. A system as in claim 1, wherein each optical signal comprises a CWDM signal.

11. A bidirectional wavelength division multiplexing system, comprising:
a first plurality of transceivers, each of the first plurality of transceivers operable to transmit an optical signal over a selected wavelength channel;
a first multiplexer for receiving an optical signal from each of the first plurality of transceivers and multiplexing the optical signals into a first multiplexed signal;
a first demultiplexer for receiving a second multiplexed signal and separating the second multiplexed signal into distinct optical signals over separate wavelength channels and directing each respective one of the optical signals to a respective one of the transceivers;
a first optical device that is configured to:
receive the first multiplexed signal and direct the first multiplexed signal onto an optical fiber such that the first multiplexed signal travels in an opposite direction as a second multiplexed signal on the optical fiber; and
receive the second multiplexed signal from the optical fiber and route the second multiplexed signal to the first demultiplexer.

12. A system as in claim 11, further comprising:
a second plurality of transceivers, each of the second plurality of transceivers operable to transmit an optical signal over a selected wavelength channel;
a second multiplexer for receiving an optical signal from each of the second plurality of transceivers and multiplexing the optical signals received from each of the second plurality of transceivers into the second multiplexed signal;
a second demultiplexer for receiving the first multiplexed signal and separating the first multiplexed signal into distinct demultiplexed signals over separate wavelength channels and directing each respective one of the optical signals to a respective one of the second plurality of transceivers;
a second optical device that is configured to:
receive the second multiplexed signal and direct the second multiplexed signal onto the optical fiber such that the second multiplexed signal travels in an opposite direction as the first multiplexed signal on the optical fiber; and
receive the first multiplexed signal from the optical fiber and route the first multiplexed signal to the second demultiplexer.

13. A system as in claim 11, wherein the first optical device comprises an interleaver for even-odd channel separation.

14. A system as in claim 11, wherein the first optical device comprises a bandpass filter and each signal in the first multiplexed signal has either a higher wavelength or a lower wavelength than each signal in the second multiplexed signal.

15. A system as in claim 11, wherein at least one optical signal traveling in the first multiplexed signal shares a wavelength channel with an optical signal traveling in the second multiplexed signal.

16. A system as in claim 15, further comprising at least one APC connector to reduce channel cross talk.

17. A system as in claim 11, wherein the first optical device comprises a circulator.

18. A system as in claim 11, wherein each of the first plurality of transceivers comprising a gigabit interface converter and each optical signal comprises a CWDM signal.

19. A system as in claim 11, wherein each optical signal comprises a DWDM signal.

20. A method for increasing data transmission capacity over a single fiber, the method comprising: receiving, at a first circulator, a first multiplexed DWDM signal over a first optical fiber and a second multiplexed DWDM signal over a second optical fiber, the first multiplexed DWDM signal comprising at least one optical signal that shares a wavelength channel with an optical signal in the second multiplexed DWDM signal, wherein the circulator couples the first multiplexed signal onto the second optical fiber and couples the second multiplexed signal onto a third optical fiber that is in communication with a DWDM demultiplexer.

21. A method as in claim 20, wherein the circulator comprises at least one APC connector to reduce channel cross talk.
